(19) United States
(12) Patent Application Publication
(10) Pub. No.: US 2013/0136870 A1
(43) Pub. Date: May 30, 2013

(54) Droplet Deposition Apparatus and Method for Manufacturing the Same

(71) Applicants: Michael Walsh, Suffolk (GB); John P. Tatum, Cambridgeshire (GB); Paul R. Drury, Royston (GB)

(72) Inventors: Michael Walsh, Suffolk (GB); John P. Tatum, Cambridgeshire (GB); Paul R. Drury, Royston (GB)

(73) Assignee: XAAR TECHNOLOGY LIMITED, Cambridge, Cambridgeshire (GB)

(21) Appl. No.: 13/813,627

(22) PCT Filed: Aug. 4, 2011
(86) PCT No.: PCT/GB2011/051481

§ 371 Date: Feb. 15, 2013

(30) Foreign Application Priority Data
Aug. 4, 2010 (GB) 1013123.3

(51) Int. Cl. B05D 3/00; B21D 53/76; B29C 35/08

(52) U.S. Cl. CPC B41J 2/1634
USPC 427/555; 29/890.1; 264/400

(57) ABSTRACT

A method of forming a component for a droplet deposition apparatus, includes the steps of: providing a protection material so as to fill fluid chambers and; directing a high-powered laser at the component so as to ablate an array of nozzles communicating with respective filter chambers. The protection material acts to inhibit damage to the walls of the chamber during ablation, such as damage to the interior passivation coating, or electrodes provided on the walls of the chamber, and can be removed for example by flushing with a heated solvent.

The present invention relates to droplet deposition apparatus and to methods for manufacturing such droplet deposition apparatus. It may find particularly beneficial application in a method for manufacturing an inkjet printhead involving the use of laser ablation on an apparatus having a plurality of chambers.

A typical droplet deposition apparatus construction involves an array of fluid chambers, each chamber being provided with a respective aperture through which fluid is forced in the form of droplets during use of the apparatus.

A variety of alternative fluids may be deposited by such an apparatus: droplets of ink may travel to, for example, a paper or other substrate to form an image in inkjet printing applications; alternatively, droplets of fluid may be used to build structures, for example electrically active fluids may be deposited onto a substrate such as a circuit board so as to enable prototyping of electrical devices.

In order to effect such droplet deposition, the apparatus may be provided with electrically actuable means, such as one or more resistive elements, which may cause rapid heating of the fluid in a chamber in response to an applied voltage, or electrostrictive elements, such as piezoelectric members, which may deform in response to an applied voltage so as to apply a force to the liquid in a chamber. As a result, the electrically actuable means may increase the pressure inside a given fluid chamber and thus cause the release a droplet of fluid through the respective aperture. The electrically actuable means may typically be electrically connected, for example by a system of electrodes, to control circuitry, so that droplet deposition from the array may be controlled.

Oftentimes, a portion of the electrically actuable means, together with the electrical connection for such means, may be closely coupled with the chamber array and, indeed, may provide a portion of the walls of the chamber, in particular where the electrically actuable means comprise electrostrictive elements, such as piezoelectric members. The electrical connectors may similarly form a portion of the chamber walls, for example by being arranged on an interior surface as a result of electroplating and patterning an electrode layer.

In order to provide a droplet deposition apparatus operable to deposit drops at high resolution it may be desirable to provide an array of chambers with very fine spacing, which accordingly requires that the apertures for the chambers are disposed with a similarly fine spacing. In addition, in order that droplets produced by all chambers are of a consistent desired size, it may be desirable that the apertures for the chambers are formed with high accuracy.

To provide for these requirements, the manufacture of droplet deposition apparatus may involve the use of one or more beams of radiation, such as those produced by a high-power laser, to form the apertures for the chambers by ablation. The chambers may be formed by a various methods of manufacture, such as photolithography, wet or drying etching, or mechanical working, for example sawing using a diamond-impregnated blade.

In some constructions, chambers will mainly be formed in the face of one component, a nozzle plate component being attached to this component to enclose the chambers. This component may be, for example, an actuator component and may be provided with one or more connections to a fluid supply. The nozzle plate component may then be formed from, or include materials that expedite the formation of nozzles; for example, polymeric material, which may be easily ablated, can be used for the regions where the nozzles are to be formed.

With such constructions, it is possible to form nozzles in the nozzle plate component either before or after attachment of the nozzle plate component to the chamber-carrying component. However, it has been found that the alignment of preformed nozzles with the chambers is complex and, more importantly, generally less accurate than the processes used to form the nozzles. This is found to be particularly the case where nozzles are formed with high accuracy by laser ablation. For this reason, it is generally preferred that the nozzle formation is carried out following the attachment of the nozzle plate component. Nozzle formation following attachment of the nozzle plate component may also be preferred through the increased mechanical and thermal stability of the nozzle plate component when attached to other components.

Further, in other constructions that do not comprise a nozzle plate component, because of the high accuracy of nozzle formation processes it is nonetheless often found to be advantageous to carry out nozzle formation at an advanced stage of assembly of the apparatus.

More generally, forming the nozzle in an apparatus at an advanced stage of assembly reduces the risk of contamination or clogging of the nozzles by, for example, bonding materials.

A common problem that arises from the manufacture of droplet deposition apparatus is for certain chambers within an array to be defective or inoperable during use, in that they are unable to produce droplets of a desired size or at all. If too many such defective chambers are present in the apparatus it may be necessary to discard the apparatus, thus reducing the efficiency of the overall manufacturing process. Indeed, the number of such defective chambers that may be tolerated is typically very small, and thus the efficiency of the overall process may be very sensitive to such defects. Further, in view of the considerable expense of raw materials and the complexity of the process, any decreases in manufacturing efficiency will be costly.

The Applicant has found that certain classes of defects may be caused at least in part during the ablation of apertures for the chambers.

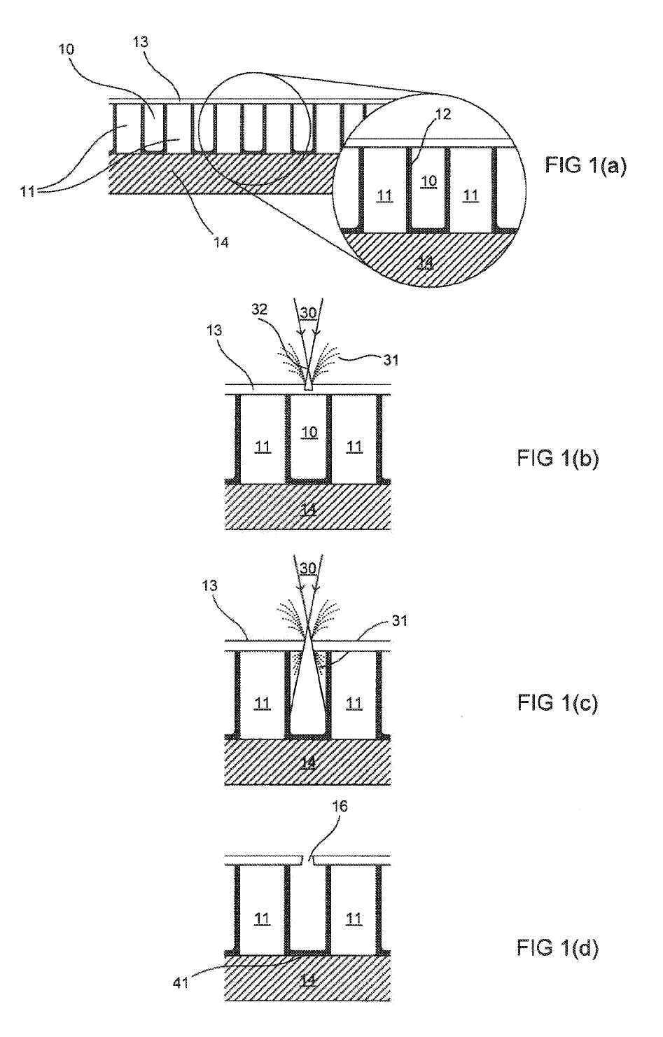

FIGS. 1(a), (b), (c) and (d) display a cross-sectional view through an exemplary apparatus undergoing such an ablation process. FIG. 1(a) shows the apparatus prior to the ablation step; the exemplary apparatus is provided with a plurality of fluid chambers (10) disposed side-by-side in an array, and electrically actuable means in the form of a corresponding plurality of piezoelectric members (11), which are arranged as walls separating the array of chambers (10). The piezoelectric members (11) are provided with electrical connection by a system of electrodes (12) formed by patterned metal plating covering the interior of each chamber. In the exemplary construction, the top surface of these walls is contacted by a plate-shaped aperture member (13), and the bottom surface is contacted by a plate-shaped support member (14).

As shown in FIG. 1(b), a beam of radiation (30) is directed at the top surface of the apparatus, and thus contacts the top surface of the aperture member (13) above a chamber (10). Material is subsequently ablated as a bore is formed through the aperture member (13), so as to provide an aperture (16) for the chamber (10) directly below the point of contact of the beam (30).

In the example shown, the beam (30) is focussed at a focal point (32) above the surface of the aperture member (13) so that the aperture (16) tapers outwardly. By appropriate changes to the focal point (32), and more generally the shape of the beam (30), a wide variety of shapes for the aperture (16) may be achieved.

Ablation debris (31) generally moves out of the bore in a plume back towards the source of the beam (upwards in FIG. 1(b)). However, whilst most ablation debris (31) is thus removed as a result of the aperture (16) being formed, it is believed that, in general, once the radiation beam (30) breaks through one wall of a respective chamber (10) and into its interior, as is shown in FIG. 1(c), damage may result from the beam (30) contacting the opposite wall of the chamber, causing unwanted ablation or scorching there, as also shown in FIG. 1(d) by scorch marks (41) on the electrodes (12).

Further, it is also believed that, once the radiation beam (30) breaks through one wall of the chamber (10) and into its interior, ablation debris (31) may cause damage to the walls of the chamber by entering and adhering or otherwise contaminating the surfaces of the interior of the chamber (10). As a result, during use of the apparatus, fluid deposition may be hindered by the reaction of the ablation debris (31) with the fluid. This may be caused, for example, by flocculation (for example in the case of gel fluids) or sedimentation of components within the fluid, or other change in properties of the fluid. Further, the debris (31) may form a corrosive mixture with the fluid. Furthermore, even before use of the apparatus, it is possible that the ablation debris (31) may react directly with the materials of the interior of the chamber (10).

Typically the depth of cut into the aperture member (13) is controlled by means of limiting the amount of radiation energy applied, for example by limiting the period of time for which the beam (30) is incident on the surface. In some cases energy may be delivered by way of a number of pulses, with the number and/or energy of these pulses being limited to control the total amount of energy applied. Such an aperture formation process may be optimised by adjusting the beam energy across the series of pulses which are used to form each aperture.

However, despite the availability of such means to limit the total amount of radiation energy delivered to the surface, efforts to prevent excess radiation energy being applied have been frustrated by unavoidable variations in the characteristics of the surface resulting from the manufacturing process. For example, if the aperture member (13) is thinner than expected, excess radiation energy may still be transmitted to the interior surfaces of the channel (10), which, as described above, may cause a variety of problems. Equally, the material at a particular location may be less easily ablated.

Further, erring on the side of caution in the amount of radiation to deliver may equally lead to defects in the apparatus since the radiation beam (30) may fail to completely form the desired aperture (16).

In addition, some materials are found to be best ablated with a moderate energy beam (or a number of moderate-energy pulses) to remove the bulk of the material, with a high-energy finishing beam (which again may be delivered by a number of pulses) used to ensure a high-quality finish to the internal surfaces of the aperture (16). Such a method is discussed in EP1 393 911B. However, given the above considerations, such a process further increases the risk of damage due to excess radiation energy since the radiative flux may remain high after the point in time when the beam has broken through into the chamber.

As noted above and exemplified in FIG. 1, since the walls of the chambers will often comprise portions of the electrically actuable means (11) that cause droplet deposition and/or electrodes (12) used to apply voltage signals to such electrically actuable means, damage to the walls of the chamber may lead to the chamber (10) being completely unable to function. It should be noted in this regard that such components may be particularly sensitive to radiation and/or heat.

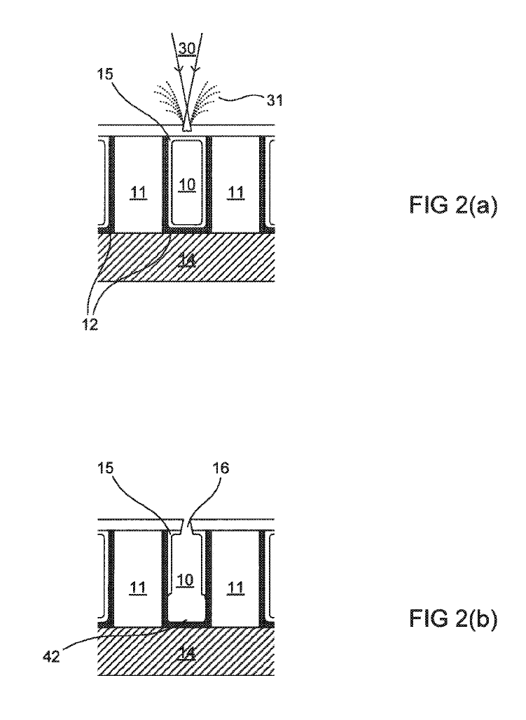

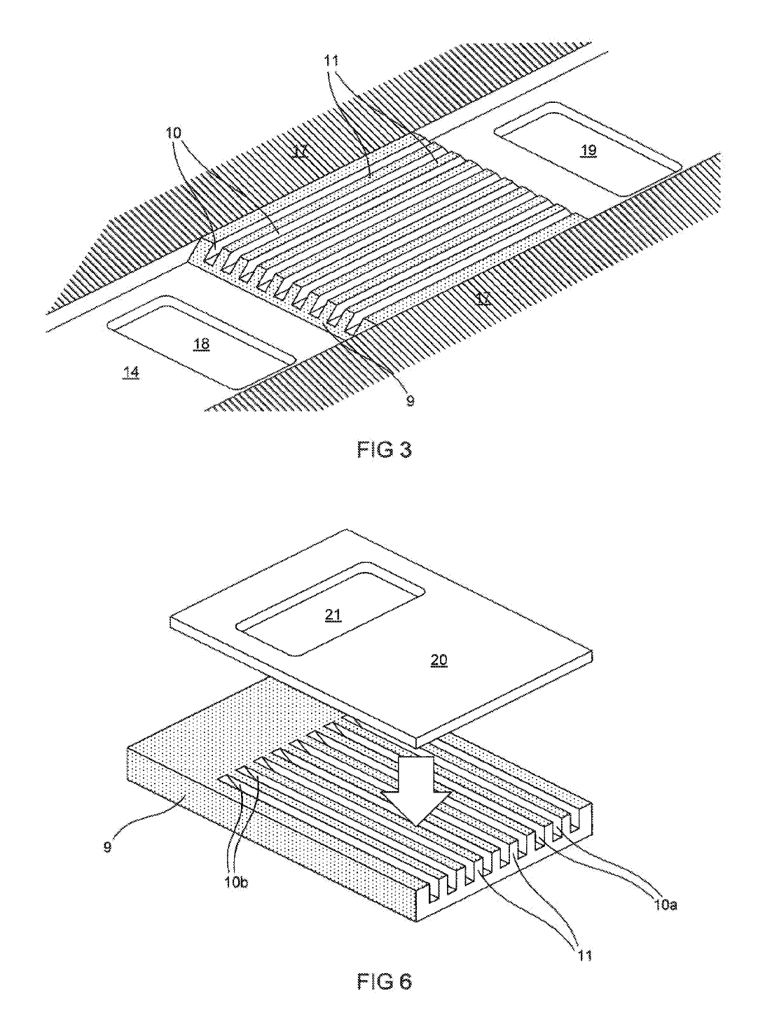

Furthermore, it has been previously proposed to pass a coating material through or over droplet deposition apparatus during manufacture so as to provide a coating or passivating layer (15) that forms part of—or in some cases substantially all of—the interior surfaces of the walls of a fluid chamber (10) (as is discussed, for example, in WO 2006/129072, where Parylene is utilised). This coating layer (15) may thus reduce chemical, electro-chemical and/or physical interaction between the fluid in the chamber and components that might otherwise form part of the chamber walls' interior surfaces such as the electrically actuable means (11) and electrodes (12) mentioned above. FIG. 2(a) shows a construction prior to undergoing aperture formation by ablation, the construction being generally similar to that shown in FIG. 1(a), but having additionally been coated in the manner described above.

Those skilled in the art will recognised that many alternative coating processes are known, such as line-of-sight deposition processes and alternative coating materials such as Silicon Nitride may suitably be used.

It should be noted that, while materials such as Parylene that are typically used in such coating processes are generally effective at reducing chemical and physical interaction between the materials of the chamber walls and the fluid within the chamber, they may have a tendency to be less resistant to the radiation used to ablate the apertures. Thus, the coating (15) will typically provide little protection to the apparatus during ablation of the apertures (16).

It has been found by the Applicant that, when apertures (16) are ablated in apparatus having chambers (10) coated in such a manner, the ablation debris (31) and the radiation beam (30) may also affect such a coating layer (15), thus exposing components forming part of the chamber walls but otherwise covered by the coating layer (15) to the fluid within the chamber. This is shown in FIG. 2(b), where portions (42) of the coating material covering the floor of a chamber have been ablated, exposing the electrode (12) for that chamber (10) and thus allowing fluid within the chamber to contact the electrode for that chamber. The fluid may thus corrode, or oxidise the electrode and as a result render the chamber inoperable.

It should further be noted that constructions where a coating layer (15) is formed conformally over all the internal surfaces of the chamber (10) such as that shown in FIGS. 2(a) and 2(b) may be preferred since the coating process may be carried out at a late stage of assembly, and thus any dust, dirt or other matter present in the chambers (10) is over-coated. However, with such constructions it is found to be particularly difficult to control the amount of radiation energy that is required to form apertures (16) fully, without causing damage the walls of the chambers. This is believed to be caused, in part, by the ease with which coating materials may be ablated, since the coating layer (15) is the final layer that must be broken through to form the nozzle and thus the ablation process is made more sensitive to excess radiation energy at one of its most crucial points. It will be appreciated that this may be exacerbated yet further by the use of a high-powered finishing beam as described above.

Such damage (42) to a coating layer (15) may also lead to failure of fluid deposition from the chamber by flocculation (for example in the case of gel fluids), sedimentation of components within the fluid, or other change in properties of the fluid, as a result of exposure to the underlying materials of the chamber interior. In particular, where conductive fluids are used, these may contact the electrodes within the chambers (10) causing blockages or flow restrictions in the apparatus owing to agglomeration of conductive particles within the fluid.

It should be noted that such problems may occur even where the coating layer (15) is not completely removed, since over time the coating layer (15) may unavoidably be worn away and thus even minor damage causes a reduction in the expected operating lifetime of the apparatus.

It is therefore an object of aspects of the present invention to overcome or ameliorate some or all of such defects and/or malfunctions caused by ablation during manufacture of droplet deposition apparatus.

Thus, there is provided in accordance with a first aspect of the present invention a method of forming a component for a droplet deposition apparatus, the component comprising an array of fluid chambers, the method comprising the steps of: providing protection material so as to fill, at least in part, said chambers; directing at least one beam of radiation at said component so as to form an array of apertures by ablation of said component, each aperture extending through a portion of said component so as to communicate with a respective chamber, in use fluid being released from said chambers through said apertures in the form of droplets to be deposited; wherein said protection material acts to inhibit damage to the walls of said chamber during said ablation; and removing said protection material.

Suitably, said protection material may inhibit damage at least in part by absorbing energy from said radiation. Specifically, such energy absorption may involve a phase change of the protection material. The phase change may include melting, which term is intended to include the transition from an amorphous solid, wax, glass or such like to a liquid. Additionally, the protection material may inhibit damage by capturing and carrying away the debris created by the ablation step when the protection material is removed.

Suitably, a chamber is filled, at least in part, with protection material prior to the formation by ablation of the aperture for that chamber. Preferably, said protection material is removed from a chamber following the formation by ablation of the aperture for that chamber. Said removal of protection material may comprise flowing a flushing fluid through the apparatus. Said flushing fluid may preferably be heated and/or may be a solvent for the protection material.

In some embodiments, protection material may be caused to flow through said chambers simultaneously with said step of forming apertures.

The one or more beams of radiation may be provided by a high-power laser.

Preferably, said protection material is in an incompressible state immediately prior to said step of directing at least one beam of radiation at the component. Protection material that does not absorb substantial amounts of radiation may remain in an incompressible state during said step of directing at least one beam of radiation at the component. As a result or otherwise, it may provide mechanical support to the wall of the chamber through which an aperture is formed. Advantageously, the protection material thus reduces the movement of the wall of the chamber through which an aperture is formed during said ablation step. Such movement may result from shock waves, which, by causing the apparatus to move, can result in poor aperture quality.

Preferably, the protection material is solid immediately prior to said step of directing at least one beam of radiation at the component. More preferably still, the protection material is preferably provided as a liquid and subsequently solidifies. Protection material that does not absorb substantial amounts of radiation may remain in a solid state during said step of directing at least one beam of radiation at the component.

Alternatively, the protection material may be provided as a liquid. Preferably, this liquid may be caused to flow continuously through the chamber during the ablation step. Suitably, the chamber may be substantially enclosed at the point when said protection material is enclosed. Such a continuous flow may improve the removal of ablation debris from the chamber. In addition, it is preferred that, immediately upon a beam of radiation breaking through the wall of a chamber in which an aperture is being formed, the beam will contact the protection material thus preventing ablation debris from spreading through the chamber. This may also enhance the ability of the protection material to mechanically support the wall of the chamber through which an aperture is formed.

In order to achieve this, or otherwise, the method may further comprise, prior to said step of directing at least one beam of radiation at the component, evacuating substantially all gaseous material from and applying a fluid-tight seal to said fluid chambers.

Suitably, for each chamber for which a communicating aperture is formed, the aperture may extend through one wall of the chamber, and further said protection material may fill the chamber so as to abut said wall leaving substantially no space adjacent said wall. Again, this may stop debris from spreading within the chamber once a beam of radiation has broken through the wall in which an aperture is being formed, and may also enhance the mechanical support of that wall.

Optionally, the method may further comprise providing a plate bounding said fluid chambers so as to form at least a portion of said walls of the fluid chambers. Preferably, said apertures extend through said plate. The plate may comprise polymeric material, and indeed may consist entirely of polymeric material. Polymeric material may allow for accurate formation of said apertures. Suitably, a continuous flow of protection material may be provided subsequently to said plate.

Further the method may optionally further comprise the step, prior to providing said protection material, of passing a coating material into said chambers, at least some of said material being deposited as a coating layer, so as to form at least a portion of said walls of the fluid chambers. The coating layer may thus form a continuous layer providing the interior surfaces of the walls of the at least some of the chambers. Preferably, at least some of said coating layer remains during use of said component so as to protect said chambers from fluid contained therein. For this reason, or otherwise, the coating material may be a chemically inert substance, such as for example poly p-xylylene or poly chloro-p-xylylene.

Optionally, the method may further comprise, prior to said step of passing a protection material into said chambers, providing one or more piezoelectric members operable to cause release of fluid from said fluid chambers through said apertures during use. The piezoelectric members may be arranged as elongate walls dividing adjacent chambers within said array, the chambers also being elongate with their lengths extending in parallel.

According to a further aspect of the present invention there is provided a component for a droplet deposition apparatus comprising a plurality of chambers, each chamber being provided with actuation means, operable during use to cause a change in pressure in fluid within said chambers, said chambers being filled at least in part with a protection material comprising a waxy material, wherein said protection material acts to inhibit damage to the walls of said chamber during ablation of apertures communicating with said chambers.

According to a still further aspect of the present invention there is provided a component for a droplet deposition apparatus comprising a plurality of chambers, each chamber being provided with actuation means, operable during use to cause a change in pressure in fluid within said chambers, said chambers being filled at least in part with a protection material that undergoes a phase change between 50 and 150° C., and preferably between 60 and 130° C., wherein said protection material acts to inhibit damage to the walls of said chamber during ablation of apertures communicating with said chambers.

Preferably, such components further comprise a plate bounding said fluid chambers so as to form at least a portion of said walls of the fluid chambers. The plate may comprise polymeric material, and indeed may consist entirely of polymeric material. Polymeric material may allow for accurate formation of said apertures.

Embodiments of the invention will now be described with reference to the accompanying drawings, in which:

FIG. 1 displays a prior art method of forming apertures of a droplet deposition apparatus by ablation;

FIG. 2 shows a prior art method similar to that of FIG. 1, but further including the application of a coating layer to the interior surfaces of the walls ;

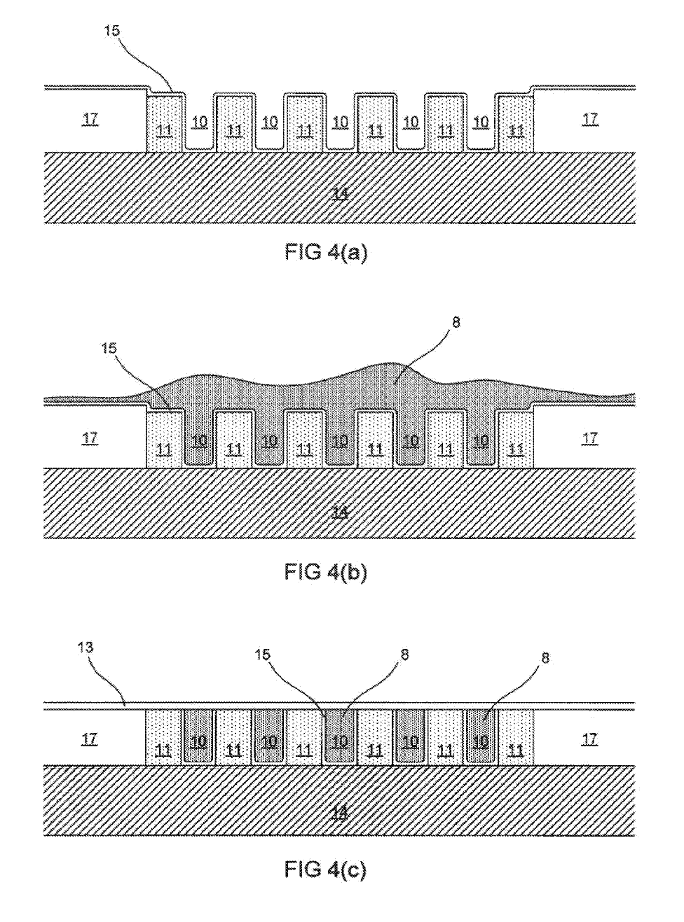

FIG. 3 shows a work piece suitable for use in a “side-shooter” configuration, prior to formation of apertures by ablation in a method according to a first embodiment of the present invention;

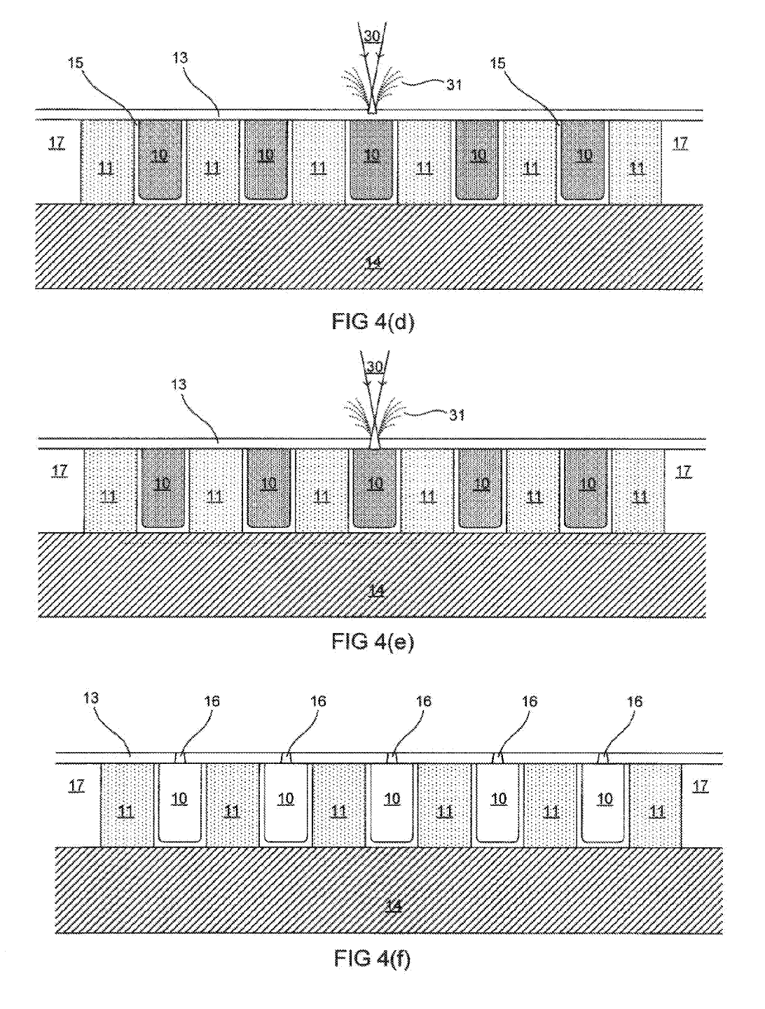

FIG. 4 illustrates the ablation of apertures in the work piece shown in FIG. 3;

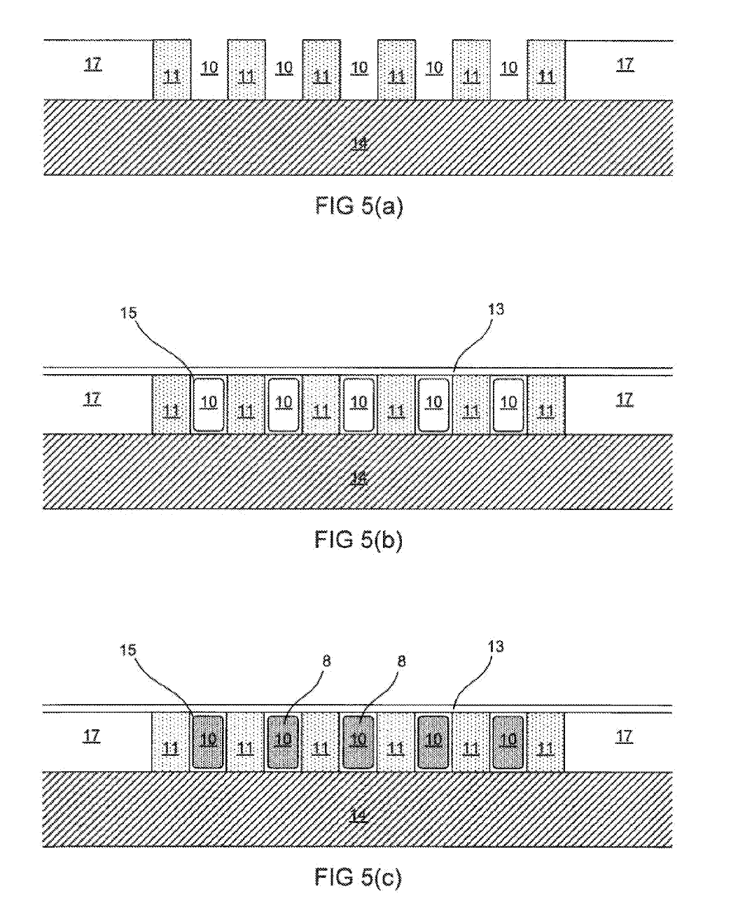

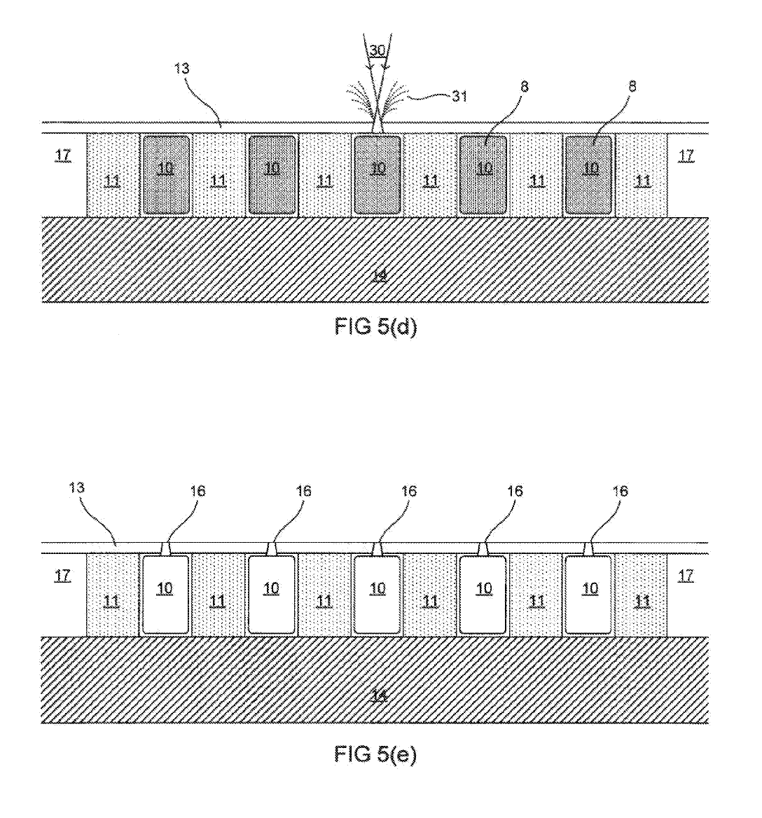

FIG. 5 illustrates a method according to a further embodiment of the present invention applied to a work piece similar to that depicted in FIG. 3, where a plate closing the chambers is attached before protection material is provided;

FIG. 6 shows a work piece suitable for use in an “end-shooter” configuration, prior to formation of apertures by ablation;

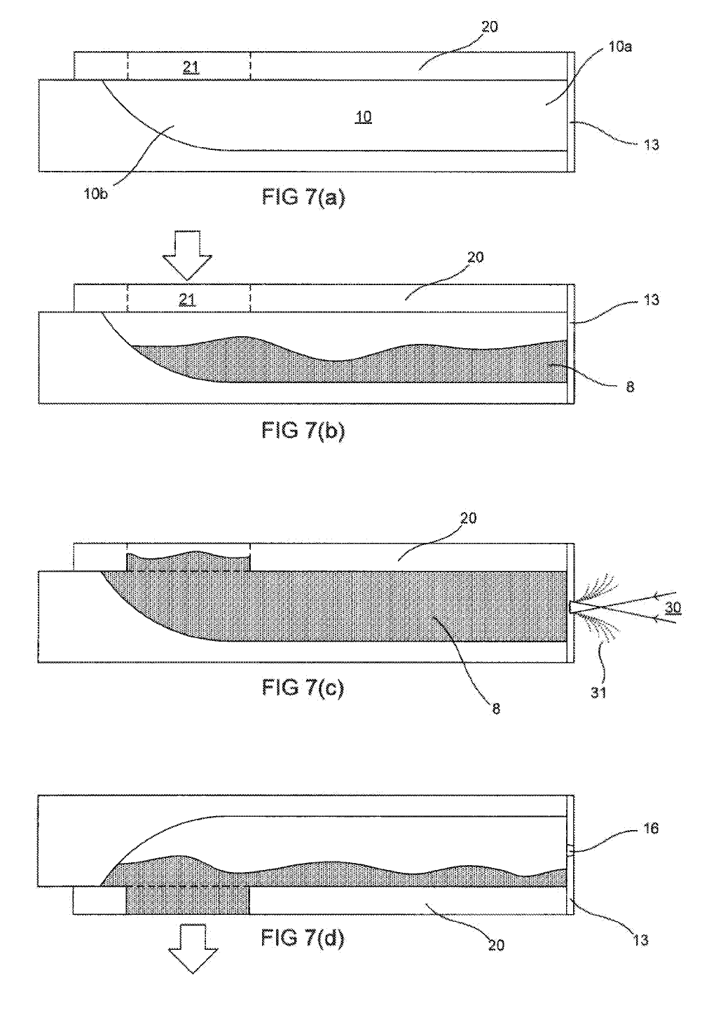

FIG. 7 illustrates the ablation of apertures in the work piece of FIG. 6 in accordance with a method according to a still further embodiment of the present invention;

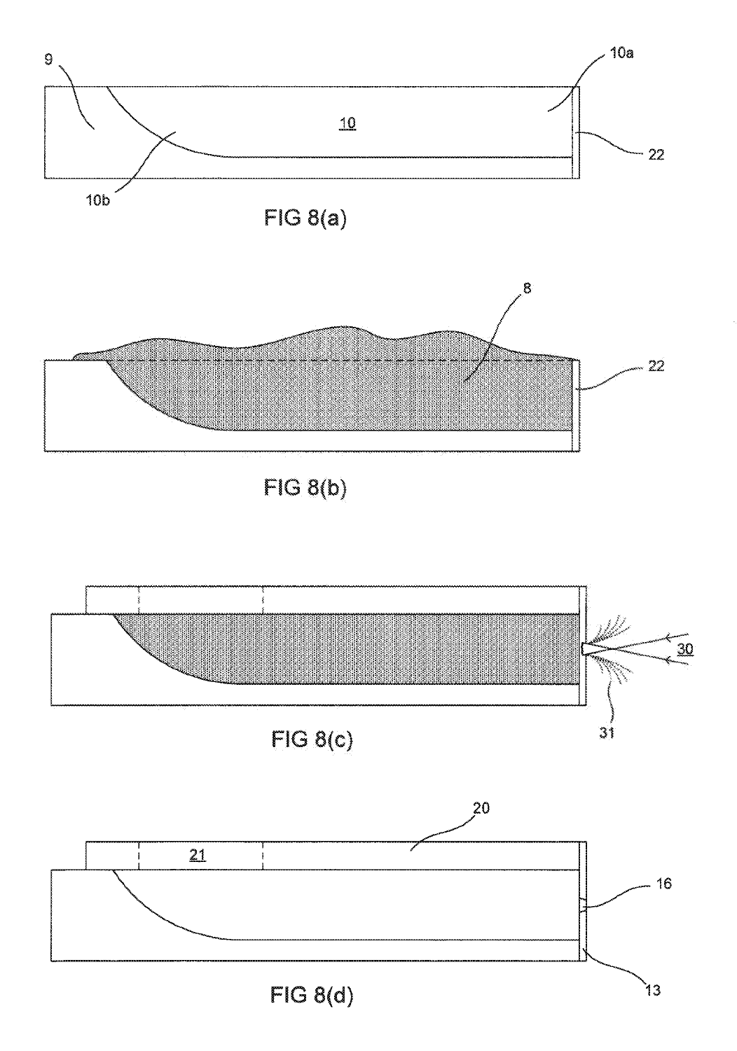

FIG. 8 illustrates a method according to yet a further embodiment of the present invention, where protection material is provided prior to the attachment of a cover member in a process to provide the work piece of FIG. 6 with apertures;

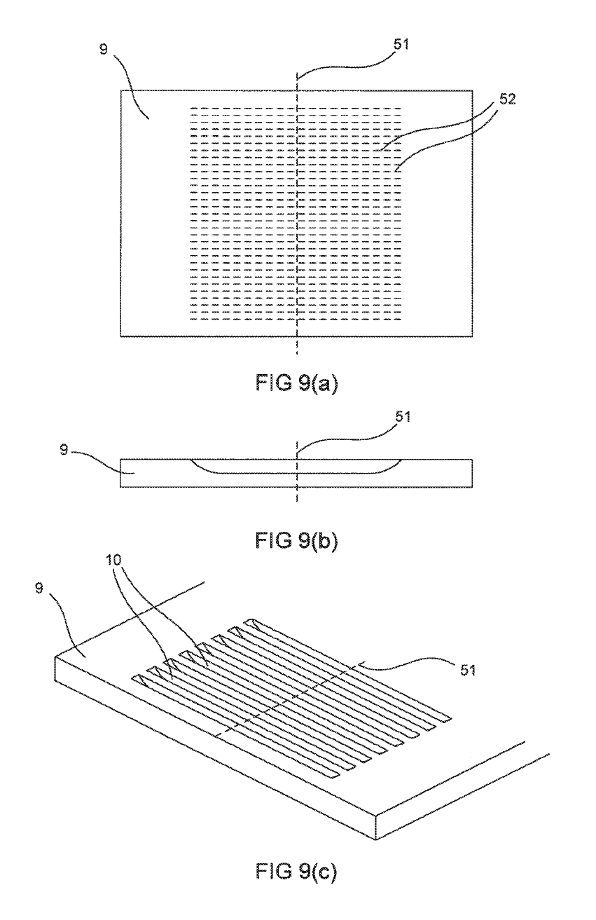

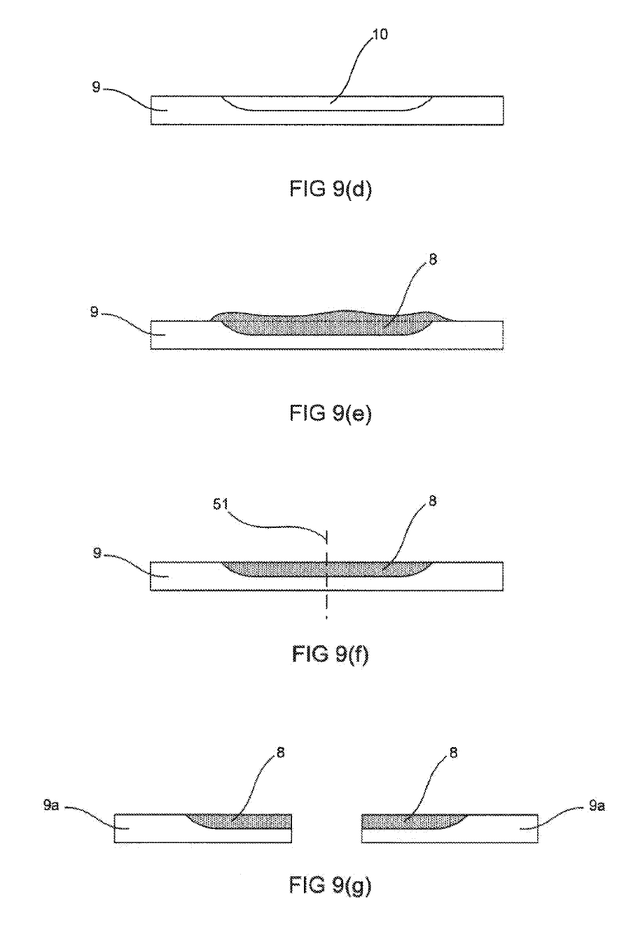

FIG. 9 illustrates a method according to a still further embodiment of the present invention, where protection material is provided prior to dicing of a piezoelectric wafer into two work pieces of similar design to that of FIG. 6; and

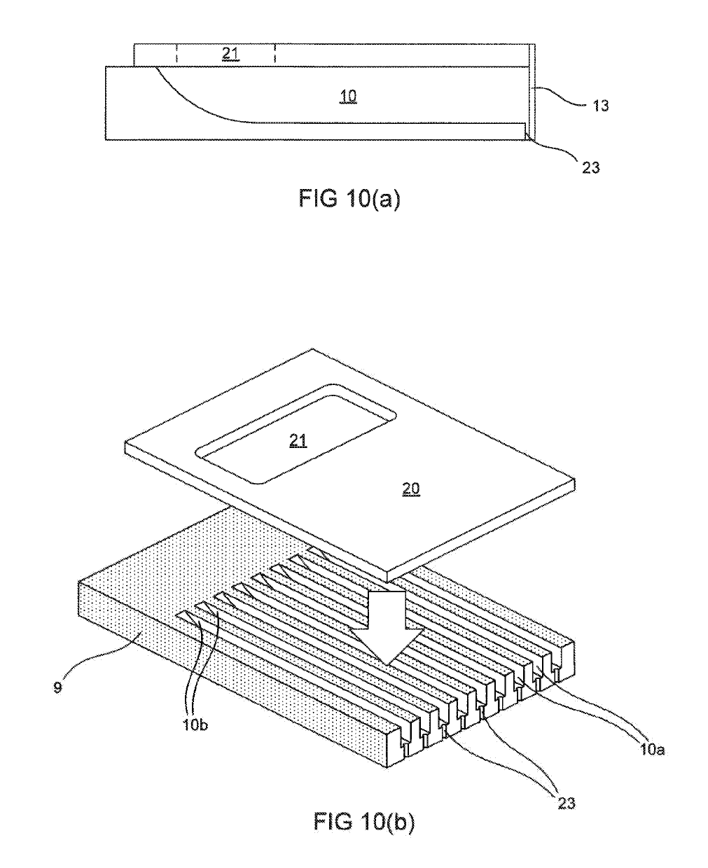

FIG. 10 displays an alternative “end-shooter” construction, for which apertures may be provided using a modification of the method illustrated in FIG. 7.

Referring now to FIGS. 3 and 4, in a first embodiment of the present invention, an ink jet printing component, which in use may form part of a printhead, is manufactured by a process including the laser ablation of a polymeric nozzle plate (13), which overlies a piezoelectric actuator member (9).

Prior to the laser ablation, a block of piezoelectric material is fixed to an alumina substrate (14). The actuator member (9) is then formed from the block of piezoelectric material by sawing a plurality of closely-spaced elongate channels in its top surface. The lengths of these channels extend in parallel from one edge of the block of piezoelectric material to the opposite edge, so that each channel has two opposing open ends. As will be described below, the open roofs of these channels are later closed so as to provide an array of fluid chambers (10) disposed side-by-side in an array.

Support members (17) are then fixed either side of the piezoelectric actuator member (9), thus completing the construction shown in FIG. 3.

The construction of FIG. 3 further includes fluid inlet (18) and fluid outlet (19) ports within the substrate (14) that respectively allow fluid communication between the chambers (10) and an inlet and outlet manifold in the completed component. During use of the apparatus there may thus be set up a flow from the inlet manifold to the outlet manifold, through each of the chambers (10) in the array along the length of the chambers.

The construction of FIG. 3 is then placed in a chamber whilst a coating material, such as Parylene (a tradename for vapour deposited compounds including poly p-xylylene and poly chloro-p-xylylene) is deposited over exposed surfaces, as shown in FIG. 4(a), which is a cross-sectional view along the length of the channels. This process creates a substantially continuous coating layer (15), which reduces physical and chemical interactions between the fluid in the chambers and the components within the apparatus.

A protection material (8) is then introduced into the fluid chambers (10). The protection material (8) may be a waxy material and, in a particular embodiment is 2,6-Diisopropyl naphthalene. Such waxy protection materials may be softened by heating and applied from the top surface of the construction into the fluid chambers (10), as shown in FIG. 4(b). The inlet (18) and outlet (19) ports are plugged so that the waxy material is retained within the construction. Pressure is then applied to the protection material (8) so that it fills the open spaces presented by the top surface. An excess of protection material (8) may be provided so that the protection material stands proud of the fluid chambers (10), ensuring that all chambers are completely filled.

The protection material (8) is allowed to harden and the entire construction—including the protection material—is planarised, for example by milling from the top surface, so that the top surface is made substantially flat and some or all of the coating layer (15) is removed from the top surface. Preferably, only a small amount of material is removed from the piezoelectric actuator member (9), because of its high cost. A nozzle plate (13), which may comprise polymeric material for improved nozzle formation, is then fixed to the thus-flattened top surface, as shown in FIG. 4(c) enclosing the roof of each channel so as to bound a plurality of elongate chambers (10) disposed side-by-side in an evenly-spaced array, with the lengths of the chambers being substantially parallel.

As the top surface of the construction is substantially flat before the nozzle plate (13) is attached, the protection material (8) contacts the bottom surface of the nozzle plate leaving very little space between.

Subsequently, a beam (30) produced by a high-powered laser is directed towards the top surface of the nozzle plate (13) so as to form an aperture (16) communicating with a corresponding chamber (10). The beam (30) ablates material from the nozzle plate (13), forming a bore; in the process, debris (31) is discharged upwards in a plume, as shown in FIG. 4(d). As the beam (30) breaks through the nozzle plate (13) it substantially immediately contacts the protection material (8) contained within the chamber (10), since there is substantially no gap between the bottom of the nozzle plate and the top surface of the protection material (8). Thus, ablation debris (31) is prevented from flooding into the chamber (10) and causing damage to the interior surfaces of the chamber. In addition, it has been found that, owing to the sudden reduction in pressure, the gas carrying the debris (31) forms a shock wave, which can transfer a large amount of energy to the portions of the apparatus near to the aperture (16). The protection material (8) provides a level of mechanical support to the nozzle plate, thus reducing the effects of such shockwaves.

The laser beam (30) heats protection material (8) in the vicinity of the point of contact; the protection material (8) thus absorbs the energy from the high-powered laser beam (30) and further assists in preventing damage occurring to the interior surfaces of the fluid chambers (10).

More specifically, in embodiments where the protection material (8) is a waxy material, a portion of this waxy material in the vicinity of the point of contact is caused to melt or sublime. The energy from the radiation is thus absorbed and used to provide the latent heat required for causing a phase change in the protection material (8). Thus, the waxy material is able reduce the amount of absorbed energy that is converted to thermal energy and as a result the temperature within the chamber (10) is moderated.

Having broken through the nozzle plate (13), the laser (30) is deactivated and re-directed at a point on the nozzle plate (13) above a different chamber (10). The ablation process is then repeated until the desired number of apertures (16) are formed communicating with respective chambers (10). Following completion of the ablation process, the protection material (8) is removed from the apparatus, for example, by passing a flushing fluid through the apparatus the from inlet port (18) to the outlet port (19), and/or by use of the apparatus to deposit the protection material (8) in the form of droplets. Further, in embodiments where the protection material (8) is a waxy material, the protection material (8) may be removed by removing the plugs occluding the inlet (18) and outlet (19) ports, gently heating the apparatus so as to melt the waxy material , and then allowing it to drain from the ports (18, 19), as shown in FIG. 4(e). Additionally, or instead, waxy materials may be removed by passing a hot flushing fluid through the apparatus as described above.

Similarly to the introduction of the protection material, the flushing liquid (hot or otherwise) may be introduced into the head from either inlet or outlet, and may leave the head through either outlet or inlet and/or the nozzles. The basic requirements of the flushing liquid may include: compatibility with the apparatus or printhead (does not attack/damage the head); and solubility of the protection material in the flushing fluid, or miscibility with the protection material substance above the melting point of the protection material (miscible enough so that agglomerates of protection material are not formed to block the channels or chambers).

The function of the flushing fluid may be to physically displace the protection material (by application of pressure) or as a medium to transport volumes of the protection material from the chamber or to act as a solvent to dissolve and subsequently remove the protection material. The solubility may be sufficient that any material left in the head after flushing will remain in solution at subsequent processing temperatures, and may be removed later in a further flushing procedure, which may utilise the droplet fluid intended for use with the apparatus.

FIG. 5(a) shows a further embodiment of the present invention, where a construction is provided initially that is similar to that described with reference to FIG. 4(a) but prior to the coating step. In further contrast to the embodiment of FIG. 4, the nozzle plate (13) is attached prior to introduction of a protection material (8).

In more detail, as shown in FIG. 5(b), the construction of FIG. 5(a) is planarised, for example by milling from the top surface so that all the uppermost surfaces are substantially level and a nozzle plate (13) is subsequently attached.

As also shown in FIG. 5(b), following attachment of the nozzle plate (13) a coating material (8) is passed into each fluid chamber (10) via the inlet (18) and/or outlet (19) ports so as to provide a substantially continuous coating layer (15) over interior surfaces of the construction and, in particular, each fluid chamber (10).

Subsequently, as shown in FIG. 5(c), a protection material (8), such as the waxy material described with reference to FIG. 4, is introduced into the interior of the apparatus via the inlet (18) and/or outlet (19) ports. In order to ensure that the fluid chambers (10) are completely filled during this process, the apparatus may be arranged so that the substrate (14) and inlet (18) and outlet (19) ports are orientated vertically upwards and thus gravity will cause the chambers (10) to fill. It may at this stage be desirable or necessary to agitate the apparatus so as to remove remaining pockets of air within the apparatus. Alternatively, the filling process may take place under vacuum or reduced pressure. The inlet (18) and outlet ports (19) may then be plugged so as to seal the protection material (8) within the apparatus. If a waxy material is used, it may be allowed to harden at this point.

Following the filling of the apparatus with the protection material (8), apertures (16) may be ablated in the nozzle plate (13) by applying the beam of a high-powered laser (30) at the top surface of the nozzle plate (13), as shown in FIG. 5(d). As described with reference to FIG. 4(d), the protection material (8) absorbs energy from the high-powered laser beam (30) and thus prevents damage occurring to the interior surfaces of the fluid chambers (10).

Once the ablation of apertures (16) is completed, the inlet (18) and outlet (19) ports may be unblocked and the protection material (8) removed in a similar manner to that described with reference to FIG. 4(e) with the protection material (8) being drained, as shown in FIG. 5(e).

In an optional modification of the embodiment of FIG. 5, the coating material (15) may be applied prior to attachment of the nozzle plate (13), as in the embodiment of FIG. 4.

Constructions, such as those depicted in FIGS. 4 and 5, where an aperture (16) or nozzle is disposed at one side of the chamber (10) with respect to its length are typically referred to as “side-shooter” constructions. It should be appreciated that the present invention may equally be applied to the manufacture of apparatus having elongate chambers, where an aperture or nozzle is formed at one end of a chamber with respect to its length; such constructions are typically referred to as “end-shooters”, an example of which is shown in FIG. 6.

In the construction of FIG. 6, a plurality of channels (10) have been sawn in the top surface of a block of piezoelectric material (9), in a similar manner to that described with reference to FIG. 3. In contrast to the channels formed in the construction of FIG. 3, however, the channels formed in the top surface of the block of piezoelectric (9) in FIG. 6 do not extend from one edge of the block to the other; instead each channel stops short with a smooth reduction in depth at a channel termination portion (10b) at one end of each channel, while the other end of the channel (10a) is open.

A cover member (20) is then attached to the top surface of the block of piezoelectric material (9) (attachment shown by large arrow in FIG. 6), substantially closing the open tops of the channels so as to provide an array of elongate fluid chambers (10) arranged side-by-side in an array, the lengths of the chambers extending parallel to each other. Optionally, prior to attachment of the cover member (20) the top surfaces of the piezoelectric block may be milled so as to make them substantially level. The cover member (20) comprises a port (21) to which a manifold may be connected, enabling fluid communication between each chamber (10) (via the channel termination end) and the manifold.

Further, a blank nozzle plate (13) (one in which no apertures have yet been formed) is attached to close the open ends of the channels (10a). FIG. 7(a) is a cross-section taken perpendicular to the length of a chamber (10), clearly displaying the open end of each channel (10a) now closed by the nozzle plate (13) and the channel termination portion (10b) at the opposite end of the channel.

Subsequently, as shown in FIG. 7(b) a protection material is flowed into each chamber (10 through the port in the cover member (21). Care must be taken at this stage to avoid air-entrapment within the chambers (10); the work-piece may therefore be agitated at this stage to remove pockets of air. If a waxy material is used as a protection material (8), it is allowed to harden at this point. As with the embodiments of FIGS. 4 and 5, it may be preferable to allow the chambers (10) to completely fill with protection material (8) so that there is no gap or space behind the nozzle plate (13).

Next, as shown in FIG. 7(c), a high-powered laser (30) is directed at the front face of the nozzle plate (13) so as to form an aperture (16) for a corresponding chamber (10) by ablation of the nozzle plate (13). This process is repeated as desired to create an array of apertures (16) providing fluid communication with respective chambers (10).

Following the ablation of apertures (16), the construction is inverted and to cause the protection material (8) to drain out via the port in the cover member (21), as illustrated in FIG. 7(d). As in embodiments described above, the protection material may in addition, or alternatively be removed by flowing a flushing fluid through the apparatus and/or by activating the apparatus to cause the protection material (8) to be deposited as droplets. In embodiments where a waxy material is used as a protection material (8), the apparatus may be heated and/or a heated flushing fluid may be utilised.

FIG. 8 illustrates a method according to yet a further embodiment of the present invention where protection material (8) is introduced into an “end-shooter” construction similar to that shown in FIG. 6 before the cover member (20) and nozzle plate (13) are attached. Instead, a releasable plate member (22) is attached to the front of the block of piezoelectric material (9) to close the open ends of the channels (10a), as shown in FIG. 8(a).

Subsequently, as shown in FIG. 8(b), the channels (10) are filled with an excess of waxy protection material (8), so that the protection material (8) stands proud of the block of piezoelectric material (9). The protection material (8) is allowed to harden at this stage.

The entire top surface of the construction, including the protection material (8), is then milled, so as to provide a flat top surface, to which a cover plate (20) such as that shown in FIG. 6 is attached, as displayed in FIG. 8(c). As also shown in FIG. 8(c), the releasable plate (22) is removed and replaced with a nozzle plate (13). Subsequently, apertures (16) are ablated in this nozzle plate (13) and the protection material (8) drained, as described with reference to FIGS. 7(c) and 7(d), thus providing the construction shown in FIG. 8(d).

It should be noted that a block of piezoelectric material having channels that extend from one edge to a point only part way across the block—such as that shown in FIG. 6—may be formed in a variety of ways. FIGS. 9(a), 9(b) and 9(c) illustrate one particular method by which such a block of piezoelectric material may be formed.

FIG. 9(a) shows a view from above a generally planar block of piezoelectric material (9), and illustrates a dicing pattern (51, 52) that may be carried out by a diamond impregnated saw. A plurality of parallel cuts (52) is made in the top surface of the block of piezoelectric material (9). As is visible in FIGS. 9(b) and 9(c), which are respectively a cross-sectional view taken perpendicular to the parallel cuts (52) and an isometric view, the parallel cuts (52) do not extend fully through the block, so that they form open-topped channels (10) in the block.

As also shown in FIGS. 9(a), 9(b) and 9(c) a separating cut (51) across the block is made at an angle to, or more preferably perpendicular to the plurality of parallel cuts (52). This separating cut (51) divides the block of piezoelectric material (9) into two smaller blocks (9a, 9b), each having a plurality of channels extending from one edge part way across that block of piezoelectric material.

The thus-formed blocks of piezoelectric material may then be filled with protection material as shown in FIG. 7 or 8.

Alternatively, however, the protection material (8) may be introduced into the channels prior to the carrying out of the separating cut (51). In more detail, FIG. 9(d) shows a cross-sectional view of the piezoelectric block (9) immediately following the making of the plurality of parallel cuts (52), the view being taken perpendicular to the parallel cuts (52) so as to show the thus-formed open-roofed channels (10). Protection material (8) is then introduced into the channels (10) as shown in FIG. 9(e). Preferably, an excess of protection material (8) is used as with previous embodiments so that the protection material stands proud of the top surface so as to ensure that the channels are completely filled.

The construction may then be planarised as shown in FIG. 9(f), for example by milling from the top surface so that the piezoelectric block (9) and protection material (8) provide a substantially planar top surface.

As shown in FIG. 9(g), a separating cut (51) is then made at angle to, and more preferably perpendicular to, the plurality of parallel cuts (52), so as to divide the piezoelectric block (9) into two smaller blocks of piezoelectric material 9(a) and 9(b), each having channels (10) that extend from one edge part the way across the respective top surfaces of the blocks of piezoelectric material (9a, 9b), with the channels being filled with protection material (8).

The protection material (8) is preferably caused to solidify or substantially increase in viscosity before the separating cut (51) is made, so that the protection material (8) may be retained within the channels (10) in the divided blocks of piezoelectric material (9a, 9b). Where a waxy material is used as a protection material (8) it may suitably be allowed to harden.

While not shown, a coating material may optionally be utilised in conjunction with the embodiments of FIGS. 7, 8 and 9. This coating material may be introduced prior to attachment of the cover member (20) and nozzle plate (13), in a similar manner to that described with reference to FIG. 4, or it may be introduced after, in a similar manner to that described with reference to FIG. 5.

It should be noted that “end-shooter” constructions have been proposed where a flow may be set up from one manifold to another along the lengths of the chambers in the array. This may be accomplished by an array of small supply channels (23) extending perpendicularly to the lengths of the fluid chambers (10).

In the example shown in FIG. 10—which is substantially similar to the construction shown in FIG. 6 apart from the presence of a plurality of such supply channels (23)—each supply channel (23) is aligned with a fluid chamber (10), the supply channel (23) communicating at one end with that fluid chamber (10), and at the other end with a fluid supply manifold. There may therefore be set up during use of the apparatus a flow of fluid from one supply manifold to the other, via the supply channel (23) and the fluid chamber (10). The supply channels (23) may be formed as grooves in either the nozzle plate component (13) or in the face of the block of piezoelectric material (9), or by any other suitable means.

In such a construction, it will be appreciated that protection material (8) may be flowed along a similar path to fill the chambers (10) before ablation. Thus, a similar method to that described with reference to FIG. 7 may be carried out, but with reduced risk of the formation of air-pockets owing to the flow of protection material through each chamber (10).

More generally, where the constructions above are provided with both an inlet (18) and an outlet port (19), or as in the embodiment of FIG. 10, with a main port (21) and supply channels (23), there may be set up during the ablation process a continuous flow of protection material through the apparatus. This will assist in carrying away both debris and heat from the ablation process.

In this way, the protection material may be introduced and/or removed via the same path which is used for ink or deposition fluid during use of the apparatus. However, the use of ink or deposition fluid paths may be indicated whether a continuous flow of protection fluid is provided or not. Nonetheless, it will be appreciated that where ink or deposition fluid supply systems allow for a continuous flow of ink or deposition fluid such a continuous flow of protection material may be particularly straightforward to achieve.

Further, with such a continuous flow of protection material (or indeed otherwise), it may be preferable to maintain a negative static pressure in the protection material within the fluid chambers of the apparatus during the ablation process. Negative pressure (lower than the pressure of the atmosphere exterior the apparatus) may ensure that the protection material remains contained within the chamber when the ablation beam breaks through into the chamber. It is noted that control of ink or droplet fluid at negative static pressures may be afforded with existing fluid supply systems, so that such systems may be adapted to provide a similar effect for the protection material.

Whilst certain of the above examples have made use of a waxy material as a protection material, this is of course not essential to the operation of the invention. The protection material may indeed be a liquid, gel, amorphous solid, glass, crystalline solid, or indeed in any other appropriate state.

For arrangements where it is desired to have a continuous flow of protection material through the apparatus during the ablation process it may be preferable to utilise a protection material that is a liquid or a gel. It may also be preferred that such protection material remains in this state during ablation and does not undergo a phase change.

Such a process may be beneficial as it can be carried out at low-temperatures and/or without a flushing step to remove the protection material. As noted above, a liquid or gel protection material might make use of existing droplet fluid supply systems, although it is noted that hot-melt fluid supply systems might equally be used for introducing waxy protection materials.

As noted above, it may, in some applications, be preferable for the protection material to exhibit a phase change in response to the application of radiation. This phase change may draw energy away from the more sensitive components within the chamber.

In addition, or alternatively, the protection material may undergo a phase change from a solid or highly viscous state to a liquid or low-viscosity state at a temperature moderately in excess of room temperature. This allows the protection material to be introduced and removed easily in its low-viscosity or liquid state by gentle heating of the apparatus, or by flushing with suitably heated fluid. In this way, the temperature increase required to cause the phase change is unlikely to damage any of the sensitive components of the apparatus.

Appropriate protection materials may comprise waxy materials, such as 2,6-Diisopropyl naphthalene, for at least the reason that they exhibit such a transition from a very high viscosity state at room temperature, to a low viscosity state at temperatures moderately in excess of room temperature. As will be discussed below, protection materials may of course comprise other waxy materials, such as paraffin wax.

In particular, it may be desirable that the phase change occurs between 50 and 150° C., or more preferably between 60 and 130° C. The exemplary protection material mentioned above 2,6-Diisopropyl naphthalene—exhibits a sharp decrease in viscosity at around 70° C.

It will be appreciated by those skilled in the art that other means for achieving a phase change may also be utilised. For example, fluids with complex rheology may be utilised which under high shear conditions become significantly less viscous. Equally, particulate matter may be introduced and removed by application of high-frequency mechanical vibration.

Additionally, it may be preferable for a protection material to be chosen in accordance with the wavelength or wavelengths of radiation utilised in the ablation process. Accordingly, the protection material may exhibit a higher absorbance at such wavelengths than elsewhere in its absorption spectrum. More specifically, it is envisaged that the attenuation provided by the protection material is at least 10 times greater than air, more preferably 100 times greater than air, and still more preferably 1000 times greater than air. Alternatively, or in addition, the protection material may have a peak in its absorption spectrum within +50 nm of the wavelength of the radiation, and preferably within +25 nm. This peak in the absorption spectrum may be a major peak.

Further, while certain materials, such as 2,6-Diisopropyl naphthalene, may exhibit desirable radiation absorbing properties and also desirable phase-change properties, it is possible to combine materials with desirable radiation absorbing properties specific to the wavelength of wavelengths of radiation utilised, and to combine such a radiation absorber with a further component to provide a protection material which exhibits the desired solidity or viscosity.

An example of such a combination would be a mixture comprising carbon black and paraffin wax: the carbon black acts as an effective radiation absorber, while the paraffin wax acts as a carrier and ensures that the mixture is highly viscous at room temperature but of suitably low viscosity with a moderate temperature increase that it may be easily introduced or removed. Equally, where a liquid radiation absorber is suitable for the particular wavelength or wavelengths, such a radiation absorber may be mixed with a solid gellant to form a protection material in a gel phase. By appropriate variations in the ratios of components within the mixture, the phase change may be set to occur at a desired temperature.

Further suitable materials will be apparent to the skilled person. For example, where it is desired to provide a liquid protection material, rather than using a mixture of a carrier and a radiation absorber, a liquid radiation absorber may be used on its own, a specific example being di-isopropyl naphthalene (mixed isomers).

More generally, the Applicant envisages that the following chemicals may serve as appropriate radiation absorbers for a range of different wavelengths:
2,6di-isopropyl naphthalene;
di-isopropyl naphthalene (mixed isomers);
acridine;
trans ethyl cinnamate;
3,3-(4,4-biphenylene)bis(2,5-diphenyl-2H-tetrazolium chloride);
naphthalene;
anthracene;
perylene;
benzo (a) pyrene;
Tinuvin 360;
Tinuvin 328;
carbon black;
titanium dioxide;
tert-Butanol Cresol 2,6-Dimethylphenol tert-butyl acetate;
octabenzone xylenol tert-butyl peroxyacetate 3-trifluoromethylphenol 2-ethylhexyl p-methoxycinnamate;
isoamyl p-methoxycinnamate;
2-phenylbenzimidazolesulphonic acid;
3-(4′-methylbenzylidene)-d,l-camphor;
5-tert-butyl-2-methylphenol 2-phenyl-2H-benzotriazole 2-methyl-2H-benzotriazole 2-methyl-4-tert-octylphenol benazol p 2-(2-hydroxy-5-tert-octylphenyl)benzotriazole 4,4′-di-tert-butyldiphenylmethane 2-amino-4-tert-amylphenol 2-(5-tert-butyl-2-hydroxyphenyl)benzotriazole octylphenol 4-tert-octylphenol 2,2′-methylenebis[6-(2h-benzotriazol-2-yl)-4-(1,1,3,3-tetramethylbutyl)phenol];
2,2′-methylenebis[6-(benzotriazol-2-yl)-4-tert-octylphenol];
bis[3-(benzotriazol-2-yl)-2-hydroxy-5-tert-octylphenyl]methane;
2,2-methylenebis(6-(2H-benzotriazol-2-yl)-4-(1,;
methylenebisbenzotriazolyltertoctylphenol];
methylene bis-benzotriazolyl tetramethylbutylphenol;
2,2′-methylenebis(6-(2h-benzotriazol-2-yl)-4-(1,1,3,3tetramethylbutyl)phenol);
phenol, 2,2-methylenebis6-(2H-benzotriazol-2-yl)-4-(1,1,3,3-tetramethylbutyl)-bemotrizole;
2,2′-methylenbis(6-(2H-benzotriazol-2-yl)-4-(1,1,3,3-tetramethylbutyl)phenol);
bis[2-hydroxy-5-tert-octyl-3-(benzotriazol-2-yl)-phenyl]-methane;
2,2″-methylenebis[6-(benzotriazol-2-yl)-4-tert-octylphenol];
bis[2-hydroxy-5-t-octyl-3-(benzotriazolyl)phenyl]methane;
2,2′-methylenebis[2-hydroxy-5-(1,1,3,3-tetramethylbutyl)-1,3-phenylene]bis(2H-benzotriazole);
2,2′-methylenebis[4-(1,1,3,3-tetramethylbutyl)-6-(2H-benzotriazol-2-yl)phenol];
2,2′-methylenebis[4-tert-octyl-6-(2H-benzotriazole-2-yl)phenol]; and
methylene bisbenzotriazoryl tetramethylbutyl phenol.

Further, the Applicant envisages that the following chemicals may serve as appropriate carriers for radiation absorbers:
paraffin wax;
laponite dispersion in water;
carboxymethyl cellulose dispersion in water;
hydroxyethyl cellulose dispersion in water;
polyacrylate dispersion in water; and
gel-forming water-soluble gums.

Still further, the Applicant envisages that the following chemicals may serve as appropriate gellants for radiation absorbers:
organoclays;
hydrogenated castor oil; and
ethylcellulose dispersion.

It should be appreciated that the use of protection material is of course not limited to the particular constructions shown in, and described with reference to, the figures. The skilled person will appreciate that methods according the present invention may be utilised with constructions where the array of chambers is neither linear, nor evenly spaced. Further, such methods may be applied to two-dimensional arrays of chambers, just as with the linear arrays described above.

It should further be appreciated that the while the above embodiments concern devices having piezoelectric actuating elements, that these are simply examples of an electrically actuable means that is operable to cause controlled release of droplets from fluid chambers. As noted above, such electrically actuable means may equally comprise resistive elements operable to heat the fluid within chambers.

Still further, the skilled reader will appreciate that while the examples above may have referred to individual apertures being formed consecutively, the teaching may equally be applied to parallel processes where a plurality of apertures are formed simultaneously. In an example of such a procedure, a single beam source may suitably be split into a plurality of sub-beams, each being focussed with respect to a different aperture (though, equally, a plurality of separate sources might be used).

1. A method of forming a component for a droplet deposition apparatus, the component comprising an array of fluid chambers, the method comprising the steps of:
providing protection material so as to fill, at least in part, said chambers;
directing at least one beam of radiation at said component so as to form an array of apertures by ablation of said component, each aperture extending through a portion of said component so as to communicate with a respective chamber, to enable in use fluid to be released from said chambers through said apertures in the form of droplets to be deposited;
wherein said protection material acts to inhibit damage to walls of said chamber during said ablation; and
removing said protection material.

2. A method according to claim 1, wherein said protection material inhibits damage at least in part by absorbing energy from said radiation.

3. A method according to claim 2, wherein said energy absorption involves a phase change of said protection material.

4. A method according to claim 1, wherein said protection material is in an incompressible state immediately prior to said step of directing at least one beam of radiation at the component.

5. A method according to claim 4, wherein said protection material is solid immediately prior to said step of directing at least one beam of radiation at the component.

6. A method according to claim 5, wherein said protection material is provided as a liquid and subsequently solidifies.

7. A method according to claim 4, wherein the method further comprises, prior to said step of directing at least one beam of radiation at the component, evacuating substantially all gaseous material from and applying a fluid-tight seal to said fluid chambers.

8. A method according to claim 1, wherein a continuous flow of said protection material is provided through said chambers during ablation of the nozzles.

9. A method according to claim 1, wherein, for each chamber for which a communicating aperture is formed, the aperture extends through one wall of the chamber, and wherein said protection material fills the chamber so as to abut said wall leaving substantially no space adjacent said wall.

10. A method according to claim 1, further comprising providing a plate bounding said fluid chambers so as to form at least a portion of said walls of the fluid chambers.

11. A method according to claim 10, wherein said plate is provided subsequent to said step of providing protection material.

12. A method according to claim 8, further comprising providing a plate bounding said fluid chambers so as to form at least a portion of said walls of the fluid chambers, wherein said plate is provided prior to said step of providing protection material.

13. A method according to claim 10, further comprising: providing an actuator member having a surface in which a plurality of depressions are formed; and attaching said plate to said surface so as to at least partially enclose the spaces within said depressions, said spaces providing, at least in part, said fluid chambers.

14. A method according to claim 11, further comprising: providing an actuator member having a surface in which a plurality of depressions are formed; and attaching said plate to said surface so as to at least partially enclose the spaces within said depressions, said spaces providing, at least in part, said fluid chambers, wherein said protection material is applied to said surface so as to fill, at least in part, said depressions.

15. A method according to claim 14, wherein said protection material substantially covers said surface, completely filling said depressions.

16. A method according claim 14, further comprising mechanically removing a portion of said protection material so as to present a level surface for attachment of said plate.

17. A method according to claim 16, wherein material from said actuator member is also removed during said step of mechanically removing said protection material, said actuator member and said protection material thus providing together a planar surface for attachment of said plate.

18. (canceled)

19. A method according to claim 13, wherein said actuator member comprises piezoelectric material.

20. A method according to claim 13, wherein said actuator member comprises piezoelectric material and said depressions are formed as a plurality of parallel elongate channels, said channels being separated by elongate walls comprising piezoelectric material.

21. A method according to claim 10, wherein said apertures extend through said plate.

22. (canceled)

23. A method according to claim 1, further comprising, prior to providing said protection material, passing a coating material into said chambers, at least some of said coating material being deposited as a coating layer, so as to form at least a portion of said walls of the fluid chambers, wherein at least some of said coating layer remains during use of said component so as to protect said chambers from fluid contained therein.

24. (canceled)

25. (canceled)

26. A method according to claim 1, further comprising, prior to passing a protection material into said chambers, providing an array of electrodes for the fluid chambers, wherein said electrodes are arranged so as to form at least a portion of said walls of the fluid chambers.

27. A method according to claim 1, wherein said step of removing said protection material comprises heating the component so as to melt the protection material.

28. A method according to claim 1, wherein said protection material preferentially absorbs radiation at the wavelength of said at least one beam of radiation.

29. A method according to claim 28, wherein said protection material has an attenuation of at least 10 time times greater than air at the wavelength of said at least one beam of radiation.

30. A method according to claim 1, wherein said protection material undergoes a phase change at a temperature between 50 and 150° C.

31. (canceled)

32. (canceled)

33. (canceled)

34. A sub-assembly for the manufacture of a droplet deposition apparatus comprising:
a plurality of chambers, each chamber being provided with an actuation element, operable during use to cause a change in pressure in fluid within said chambers, said chambers being filled at least in part with a protection material comprising a waxy material, wherein said protection material acts to inhibit damage to the walls of said chamber during ablation of apertures communicating with said chambers; a plate bounding said fluid chambers so as to form at least a portion of said walls of the fluid chambers; an actuator member having a surface in which a plurality of depressions are formed, said plate being attached to said surface so as to at least partially enclose the spaces within said depressions, said spaces providing, at least in part, said chambers.

35. A sub-assembly according to claim 34, wherein said depressions are formed as a plurality of parallel elongate channels and said channels are separated by elongate walls comprising piezoelectric material, each actuation element comprising a respective one of said elongate walls.

36. (canceled)

37. A sub-assembly according to claim 34, wherein said actuator member comprises piezoelectric material.

38. (canceled)

39. (canceled)

40. (canceled)

41. A sub-assembly according to claim 34, wherein said protection material undergoes a phase change between 50 and 150° C.

42. A sub-assembly according to claim 34, wherein said protection material comprises a waxy material.
